(19) United States
(12) Patent Application Publication
(10) Pub. No.: US 2012/0131085 A1
(43) Pub. Date: May 24, 2012

(54) SYSTEM AND METHOD FOR PROVIDING ACCESS TO A WORK

(75) Inventors: Hussam HABIB, Danville, CA (US); Frederick M. ARMANINO, San Antonio, TX (US); Bruce RATCLIFFE, Livermore, CA (US); Phil SPHICAS, San Ramon, CA (US)

(73) Assignee: AT&T INTELLECTUAL PROPERTY I, L.P., Reno, NV (US)

(21) Appl. No.: 12/949,224

(22) Filed: Nov. 18, 2010

(51) Int. Cl. G06F 15/16

(52) U.S. Cl. 709/202

(57) ABSTRACT

A method for providing access to a work at a preferred device includes: receiving, from an entity, a request to send a copy of a work to a preferred device; sending a query to a database to determine whether the entity is permitted to access the work; receiving a response to the query; and sending a copy of the work to the preferred device, when the response to the query indicates that the entity is permitted to access the work. The database stores, for each of a plurality of entities, a record of works that each respective entity is permitted to access, irrespective of format.

### BACKGROUND

1. Field of the Disclosure

The present disclosure relates to controlling access to a work. More particularly, the present disclosure relates to a system and method for establishing a right of an entity to access a work on any device of the entity's preference.

2. Background Information

Currently, when a consumer purchases a copy of a copyrighted work (such as a literary work, music, a video, or a software application), it is often in a digital format, due to the increasing popularity of digital devices such as e-book readers, digital media players, high-definition televisions, smartphones and tablet devices.

However, many consumers own copies of works which are in a non-digital format, or in an older format not compatible with newer devices, such as standard books, CDs or DVDs. If a consumer wishes to access such a work with a newer device or in a newer format, such as with an e-book reader, a digital media player, or in a high-definition format, the consumer must purchase another copy of the desired work.

### BRIEF DESCRIPTION OF THE DRAWINGS

FIG. 1 shows an example of a general computer system that may include a set of instructions for providing access to a work, as described herein;

FIG. 2 shows an example of content account records stored in a network-based database used in the presently disclosed system and methods; and

FIG. 3 shows a method for providing access to a work, according to an aspect of the present disclosure.

### DETAILED DESCRIPTION

In view of the foregoing, the present disclosure, through one or more of its various aspects, embodiments and/or specific features or sub-components, is thus intended to bring out one or more of the advantages as specifically noted below.

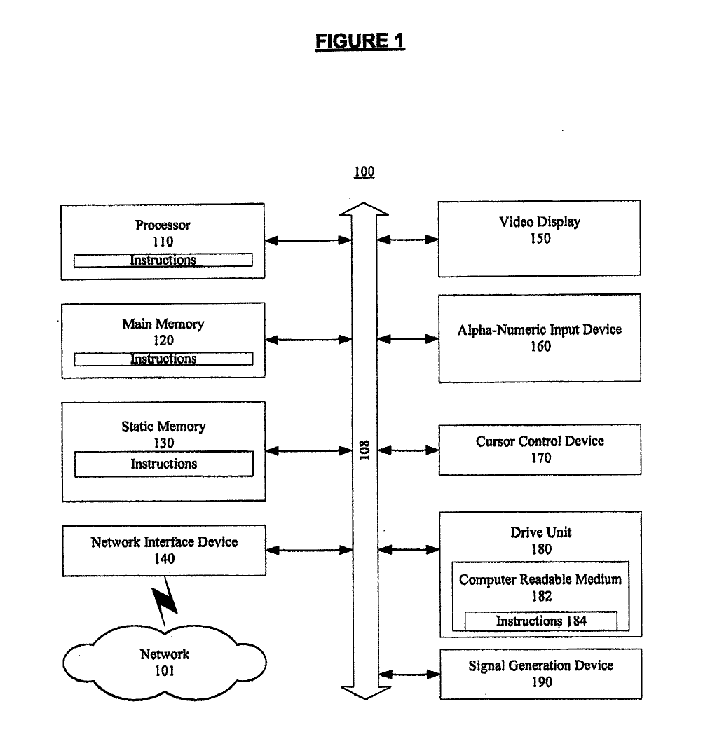

FIG. 1 is an illustrative embodiment of a general computer system that may include a set of instructions for performing processes as described herein. The general computer system is shown and is designated 100. The computer system 100 can include a set of instructions that can be executed to cause the computer system 100 to perform any one or more of the methods or computer based functions disclosed herein. The computer system 100 may operate as a standalone device or may be connected, for example, using a network 101, to other computer systems or peripheral devices. For example, the computer system 100 may include or be included within any one or more of the computers, servers, systems, or communication networks described herein.

In a networked deployment, the computer system may operate in the capacity of a server or as a client user computer in a server-client user network environment, or as a peer computer system in a peer-to-peer (or distributed) network environment. The computer system 100, or portions thereof, can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a personal trusted device, a web appliance, or any other machine capable of executing a set of instructions (sequential or otherwise) that specify actions to be taken by that machine. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

As illustrated in FIG. 1, the computer system 100 may include a processor 110, for example, a central processing unit (CPU), a graphics processing unit (GPU), or both. Moreover, the computer system 100 can include a main memory 120 and a static memory 130 that can communicate with each other via a bus 108. As shown, the computer system 100 may further include a video display unit 150, such as a liquid crystal display (LCD), an organic light emitting diode (OLED), a flat panel display, a solid state display, or a cathode ray tube (CRT). Additionally, the computer system 100 may include an alpha-numeric input device 160, such as a keyboard, another input device (not shown), such as a remote control device having a wireless keypad, a keyboard, a microphone coupled to a speech recognition engine, a camera such as a video camera or still camera, and a cursor control device 170, such as a mouse. The computer system 100 can also include a disk drive unit 180, a signal generation device 190, such as a speaker or remote control, and a network interface device 140.

In a particular embodiment, as depicted in FIG. 1, the disk drive unit 180 may include a computer-readable medium 182 in which one or more sets of instructions 184, e.g. software, can be embedded. A computer-readable medium 182 is a tangible, non-transitory article of manufacture, from which sets of instructions 184 can be read. Further, the instructions 184 may embody one or more of the methods or logic as described herein. In a particular embodiment, the instructions 184 may reside completely, or at least partially, within the main memory 120, the static memory 130, and/or within the processor 110 during execution by the computer system 100. The main memory 120 and the processor 110 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations, or combinations thereof.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium 182 that includes instructions 184 or receives and executes instructions 184 responsive to a propagated signal, so that a device connected to a network 101 can communicate voice, video or data over the network 101. Further, the instructions 184 may be transmitted or received over the network 101 via the network interface device 140.

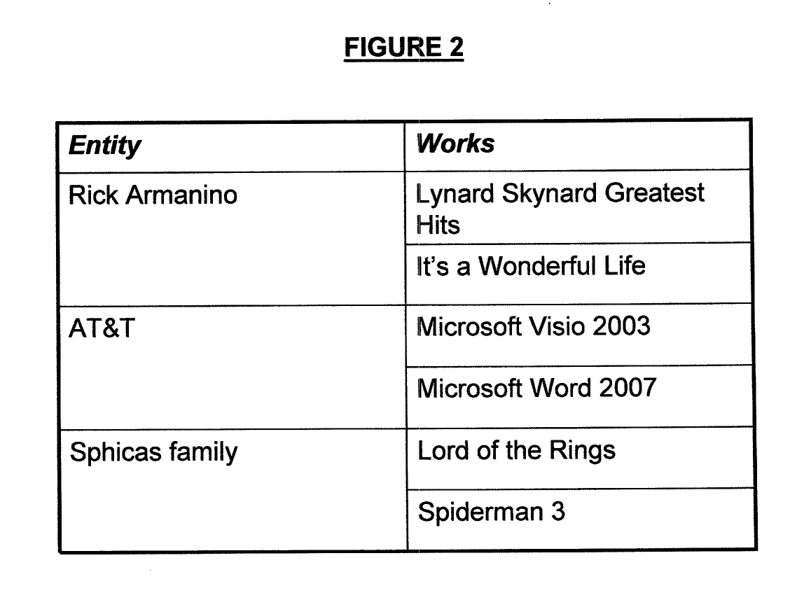

FIG. 2 illustrates an example of content account records stored in a network-based database used in the presently disclosed system and methods. The database provides a framework for establishing a record of digital rights for an entity, by storing data of a content account. The database may be stored, for example, in one or more servers, computers, data storage devices, and/or data centers, and may reside in a cloud computing infrastructure. The database may be remotely accessed by a content distributor over the internet, and may be accessible via a user interface such as a web browser.

A content account is a record of works which an entity is permitted to access, irrespective of format. A work, as described herein, includes, but is not limited to, a literary work, a musical work, a dramatic work, or other creative or artistic work. Non-limiting examples of a work include a story or other work of authorship, a song or album, a movie, a television show, a software application, a game, and a ringtone.

The database stores data for a plurality of content accounts. Each content account is associated with an entity. An entity may be, for example, a single person, a family, a business institution, or other organization.

The data stored in the database for each content account may include an entity identifier, such as the entity's name, and an identifier of each work the entity is permitted to access, such as an album name, software name, or name of a literary work. The database may be maintained by a third party, independent of and trusted by content producers and distributors.

An entity may add a work to its content account by establishing that it has obtained ownership of a copy of the work in some format. As an example, a person may obtain ownership of a copy of an album by purchasing a compact disc (CD), record or tape containing the album. One manner in which a person may establish that he or she has obtained ownership of a copy of an album may be by presenting his or her CD at a retail store. To add the album to the person's content account, a store employee may scan in the CD at a terminal, which connects to the database and updates the person's content account. Alternatively, special kiosks may be installed in public locations, such as a supermarket or mall, which allow a person to update their content account. A person may scan in their CDs at a kiosk, which connects to the database and updates the person's content account. In order to add a work to an entity's content account, the terminal or kiosk must have the functions to receive, and transmit to the database, an identification of the entity and an identification of the work.

As another example, a person may bring a book they own to a retail store or kiosk, in order to add the literary work contained in the book to their content account. As another example, a person may bring a DVD to a retail store or kiosk, in order to add the video contained in the DVD to their content account.

As another example, an entity may add software to its content account by purchasing a copy of the software. If the software is purchased at a retail store, the purchasing entity's content account may be updated in the same manner as described above. Alternatively, the content account may be updated upon the entity registering the software. Alternatively, if the entity downloads the software from an internet website, the website may connect to the database and add the software to the entity's content account.

As another example, a person may add a song to his or her content account by purchasing the song from an online media distribution service. Upon the purchase of the song, the online media distribution service may connect to the database, and add the purchased song to the person's content account.

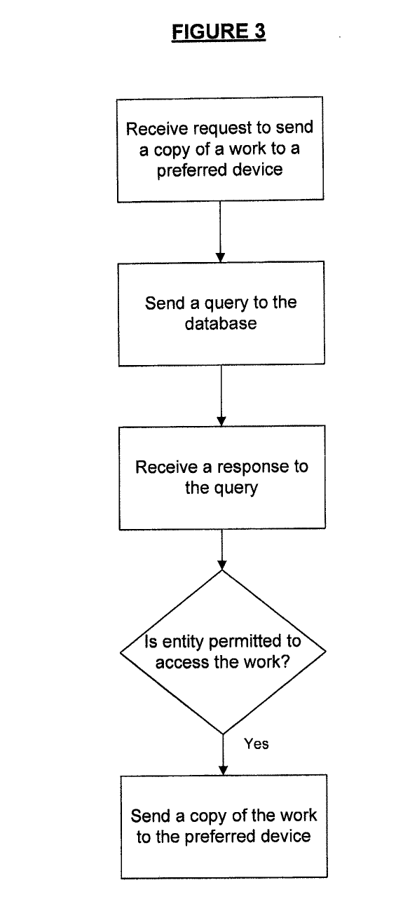

FIG. 3 illustrates a method for providing access to a work. When an entity desires a copy of a work, the entity sends a request for a copy of the work to a content distributor. For example, the entity may request that a copy of the work be sent in a digital format to a preferred device.

As an example, a person may access the website of a content distributor via the interne, and request that the content distributor download a copy of a work to a preferred device of the person. For example, the person may request music, a video, a television show, a game, an e-book, an audiobook, a podcast, a software application, or a ringtone, and request that the work be downloaded to a smartphone, a digital music player, or a tablet device. As another example, a person may select a video or television show through a television set-top box, and request that the television provider send the desired program to the person's set-top box.

The request may be received by a web server or a video server of the content distributor. The web server or video server may be run on a computer system including a computer or a network of computers. The content distributor may determine the entity's identification, for example, based on the request, or based on a device address or account originating the request. The requested work may be identified by a title, or by an identification number, such as a ISBN number. The destination device for the request may be identified by user input, or based on the device address or account originating the request.

When the content distributor receives the request, the content distributor sends a query to the database to determine whether the entity is permitted to access the requested work. The query may be generated, for example, by a web server, a video server, a content delivery platform, or other computer system of the content distributor. The query identifies the requesting entity and the requested work.

The database looks up the content account record of the requesting entity and determines whether the requested work is listed in the content account record. If the requested work is listed in the content account record, the database formulates a response to the query indicating that the requesting entity is permitted to access the work.

The database returns a response to the query to the content distributor. If the response to the query indicates that the entity is permitted to access the work, the content distributor sends a copy of the work to the entity's preferred device. For example, the content distributor may send a copy of the work in a digital format to the entity's television set-top box, computer, game console, cellphone, smartphone, PDA, tablet device, digital media player, or e-book reader.

The provision of the database and content accounts of the presently disclosed system allows an entity to purchase a copy of a work in a first format (for example, a book or CD), and then request that a copy of the work be sent in a second format to a preferred device (for example, in a digital format to an e-book reader or digital music player). The entity may also request that a copy of the work be sent in other formats to other devices. That is, once the entity has purchased a copy of the work and recorded the purchase in its content account, the database provides the entity with the freedom to access the work in any preferred format on any preferred device.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

According to an aspect of the present disclosure, a method for providing access to a work at a preferred device includes: receiving, from an entity, a request to send a copy of a work to a preferred device; sending a query to a database to determine whether the entity is permitted to access the work; receiving a response to the query; and sending a copy of the work to the preferred device, when the response to the query indicates that the entity is permitted to access the work. The database stores, for each of a plurality of entities, a record of works that each respective entity is permitted to access, irrespective of format.

The entity is permitted to access the work, irrespective of format, when the entity purchases a copy of the work in a first format, and sending a copy of the work to the preferred device may include sending the copy of the work to the preferred device in a second format. The method may also include receiving, from the entity, a request to send a second copy of the work to a second device; and sending a second copy of the work to the second device. A copy of the work may be sent to the preferred device in a first format, and the second copy of the work may be sent to the second device in a second format.

The request may be received by a computer network of a content distributor, and the computer network may send the copy of the work to the preferred device by downloading the copy of the work to the preferred device. The database may be stored in a network of a third party distinct from the content distributor.

The work may be one of music, a video, a television show, a game, an e-book, an audiobook, a podcast, a software application, and a ringtone. The preferred device may be one of a television set-top box, computer, game console, cellphone, smartphone, PDA, tablet device, digital media player, and e-book reader.

According to another aspect of the present disclosure, a computer system for providing access to a work at a preferred device includes at least one server programmed to: receive, from an entity, a request to send a copy of a work to a preferred device; send a query to a database to determine whether the entity is permitted to access the work; receive a response to the query; and send a copy of the work to the preferred device, when the response to the query indicates that the entity is permitted to access the work. The database stores, for each of a plurality of entities, a record of works that each respective entity is permitted to access, irrespective of format.

According to another aspect of the present disclosure, a non-transitory computer-readable medium stores a program for providing access to a work at a preferred device. The program includes: code for receiving, from an entity, a request to send a copy of a work to a preferred device; code for sending a query to a database to determine whether the entity is permitted to access the work; code for receiving a response to the query; and code for sending a copy of the work to the preferred device, when the response to the query indicates that the entity is permitted to access the work. The database stores, for each of a plurality of entities, a record of works that each respective entity is permitted to access, irrespective of format.

While a computer-readable medium herein may be shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present specification describes components and functions that may be implemented in particular embodiments with reference to particular standards and protocols, the disclosure is not limited to such standards and protocols. For example, standards for power over ethernet represent an example of the state of the art. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for providing access to a work at a preferred device, comprising:
receiving, from an entity, a request to send a copy of a work to a preferred device;
sending a query to a database to determine whether the entity is permitted to access the work;
receiving a response to the query; and
sending a copy of the work to the preferred device, when the response to the query indicates that the entity is permitted to access the work,
wherein the database stores, for each of a plurality of entities, a record of works that each respective entity is permitted to access, irrespective of format.

2. A method according to claim 1, wherein the entity is permitted to access the work, irrespective of format, when the entity purchases a copy of the work in a first format, and sending a copy of the work to the preferred device comprises sending the copy of the work to the preferred device in a second format.

3. A method according to claim 1, further comprising:
receiving, from the entity, a request to send a second copy of the work to a second device; and
sending a second copy of the work to the second device,
wherein a copy of the work is sent to the preferred device in a first format, and the second copy of the work is sent to the second device in a second format.

4. A method according to claim 1, wherein the request is received by a computer network of a content distributor, and the computer network sends the copy of the work to the preferred device by downloading the copy of the work to the preferred device.

5. A method according to claim 4, wherein the database is stored in a network of a third party distinct from the content distributor.

6. A method according to claim 1, wherein the work comprises one of music, a video, a television show, a game, an e-book, an audiobook, a podcast, a software application, and a ringtone.

7. A method according to claim 1, wherein the preferred device comprises one of a television set-top box, computer, game console, cellphone, smartphone, PDA, tablet device, digital media player, and e-book reader.

8. A computer system for providing access to a work at a preferred device, the computer system comprising at least one server programmed to:
receive, from an entity, a request to send a copy of a work to a preferred device;
send a query to a database to determine whether the entity is permitted to access the work;
receive a response to the query; and
send a copy of the work to the preferred device, when the response to the query indicates that the entity is permitted to access the work,
wherein the database stores, for each of a plurality of entities, a record of works that each respective entity is permitted to access, irrespective of format.

9. A computer system according to claim 8, wherein the entity is permitted to access the work, irrespective of format, when the entity purchases a copy of the work in a first format, and the at least one server is programmed to send a copy of the work to the preferred device in a second format.

10. A computer system according to claim 8, wherein the at least one server is programmed to:
receive, from the entity, a request to send a second copy of the work to a second device; and
send a second copy of the work to the second device,
wherein a copy of the work is sent to the preferred device in a first format, and the second copy of the work is sent to the second device in a second format.

11. A computer system according to claim 8, wherein the computer system is part of computer network of a content distributor.

12. A computer system according to claim 11, wherein the database is stored in a network of a third party distinct from the content distributor.

13. A computer system according to claim 8, wherein the copy of the work comprises one of music, a video, a television show, a game, an e-book, an audiobook, a podcast, a software application, and a ringtone.

14. A computer system according to claim 8, wherein the preferred device comprises one of a television set-top box, computer, game console, cellphone, smartphone, PDA, tablet device, digital media player, and e-book reader.

15. A non-transitory computer-readable medium which stores a program for providing access to a work at a preferred device, the program comprising:
code for receiving, from an entity, a request to send a copy of a work to a preferred device;
code for sending a query to a database to determine whether the entity is permitted to access the work;
code for receiving a response to the query; and
code for sending a copy of the work to the preferred device, when the response to the query indicates that the entity is permitted to access the work,
wherein the database stores, for each of a plurality of entities, a record of works that each respective entity is permitted to access, irrespective of format.

16. A computer-readable medium according to claim 15, wherein the entity is permitted to access the work, irrespective of format, when the entity purchases a copy of the work in a first format, and the code for sending a copy of the work to the preferred device comprises code for sending the copy of the work to the preferred device in a second format.

17. A computer-readable medium according to claim 15, wherein the program further comprises:
code for receiving, from the entity, a request to send a second copy of the work to a second device; and
code for sending a second copy of the work to the second device,
wherein a copy of the work is sent to the preferred device in a first format, and the second copy of the work is sent to the second device in a second format.

18. A computer-readable medium according to claim 15, wherein the program is executable by a server of a computer network of a content distributor.

19. A computer-readable medium according to claim 15, wherein the work comprises one of music, a video, a television show, a game, an e-book, an audiobook, a podcast, a software application, and a ringtone.

20. A computer-readable medium according to claim 15, wherein the preferred device comprises one of a television set-top box, computer, game console, cellphone, smartphone, PDA, tablet device, digital media player, and e-book reader.
